(19) United States
(12) Patent Application Publication
(10) Pub. No.: US 2013/0182345 A1
(43) Pub. Date: Jul. 18, 2013

(54) HEADBAND MOUNTED REARVIEW MIRROR

(71) Applicant: Brian Patella, Uxbridge, MA (US)

(72) Inventor: Brian Patella, Uxbridge, MA (US)

(21) Appl. No.: 13/351,189

(22) Filed: Jan. 16, 2012

(51) Int. Cl. G02B 7/198

(52) U.S. Cl. 359/880

(57) ABSTRACT

A rearview mirror, mounted in a headband, is adapted to be worn about the head of an individual. The headband mounted rearview mirror may provide a stable and secure attachment for the rearview mirror and may allow a user to see an area behind them. The headband mounted rearview mirror may include an attachment member, pivots, a strut, and one or more rearview mirrors.

### BACKGROUND OF THE INVENTION

The present invention relates to exercise accessories and, more particularly, to a headband mounted rearview mirror.

Currently, rearview mirrors are used by cyclists, skateboarders, runners, or the like to see an area behind them. Current rearview mirrors are mounted on eye wear frames and/or helmets. These rearview mirrors may be unstable and may allow the mirror to move with body motion. Moreover, these conventional rearview mirrors may break or be damaged with the mounting fails and the mirror falls to the ground.

As can be seen, there is a need for an improved mounting for a rearview mirror for an individual.

### SUMMARY OF THE INVENTION

In one aspect of the present invention, a rearview mirror apparatus comprises a rearview mirror; a strut; a first pivot joint adapted to pivotally connect the rearview mirror with a first end of the strut; an attachment member adapted to be attached to a headband; and a second pivot joint adapted to pivotally connect the attachment member with a second, opposite end of the strut.

In another aspect of the present invention, a headband comprises an attachment member attached to the headband; a rearview mirror; a strut; a first pivot joint adapted to pivotally connect the rearview mirror with a first end of the strut; and a second pivot joint adapted to pivotally connect the attachment member with a second, opposite end of the strut.

In a further aspect of the present invention, a headband comprises an attachment member attached to the headband; a rearview mirror; a flexible strut connecting the rearview mirror with the attachment member.

These and other features, aspects and advantages of the present invention will become better understood with reference to the following drawings, description and claims.

### BRIEF DESCRIPTION OF THE DRAWINGS

FIG. 1 is a side view of a headband mounted rearview mirror, in use, according to an exemplary embodiment of the present invention;

FIG. 2 is a front view of the headband mounted rearview mirror of FIG. 1, in use;

FIG. 3 is a perspective view of the headband mounted rearview mirror of FIG. 1;

FIG. 4 is a cross-sectional view taken along line 4-4 of FIG. 3; and

FIG. 5 is a front view of a headband mounted rearview mirror, in use, according to another exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a rearview mirror mounted in a headband that is adapted to be worn about the head of an individual. The headband mounted rearview mirror may provide a stable and secure attachment for the rearview mirror and may allow a user to see an area behind them. The headband mounted rearview mirror may include an attachment member, pivots, a strut, and one or more rearview mirrors.

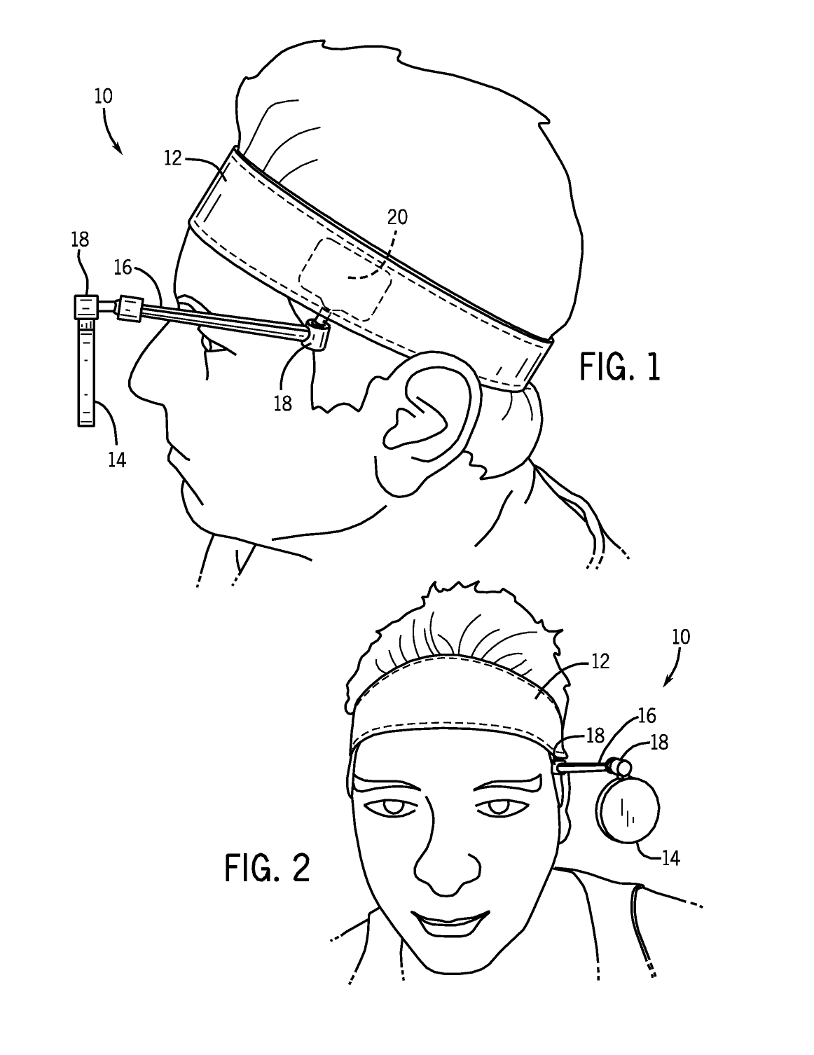

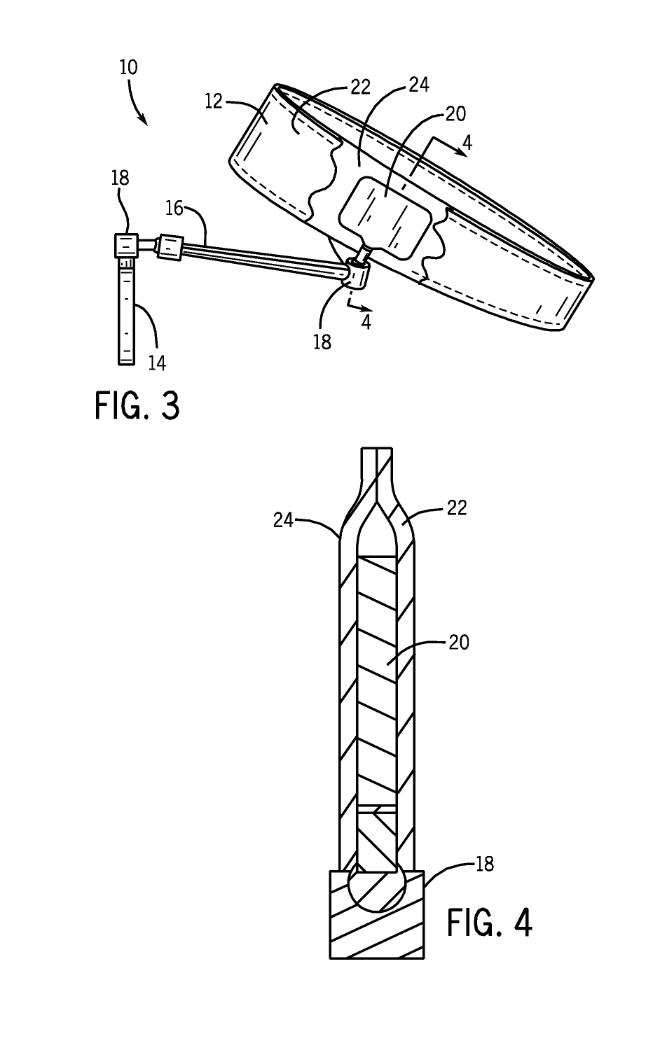

Referring now to FIGS. 1 through 4, a rearview mirror/headband assembly 10 may include a headband 12 designed to be placed around a user's head with the front of the headband 12 covering the area above the brow on the forehead and continuing around the head, typically above the ears.

An attachment member 20 may be fastened to the headband 12 by various means. For example, the attachment member 20 may be sandwiched between an outer layer 22 of the headband 12 and an inner layer 24 of the headband 12. In some embodiments, stitching may be disposed on each side of the attachment member 20, stitching the outer layer 22 to the inner layer 24 to prevent movement of the attachment member 20 between the two layers 22, 24 of the headband 12. In other embodiments, the attachment member 20 may be affixed to the headband 12 via an adhesive. The attachment member 20 may be made of a rigid or semi-rigid material made of metal, plastic, composite or the like. In some embodiments, the attachment member 20 may have a rectangular shape, typically with a height such that top and bottom edges of the attachment member 20 are disposed adjacent to the top and bottom inside edges of the headband 12.

A pivot joint 18 may be attached to an arm extending from a portion of the attachment member 20. In some embodiments, the arm may extend from a central portion of an edge of the attachment member and may extend downward, outside of the headband 12.

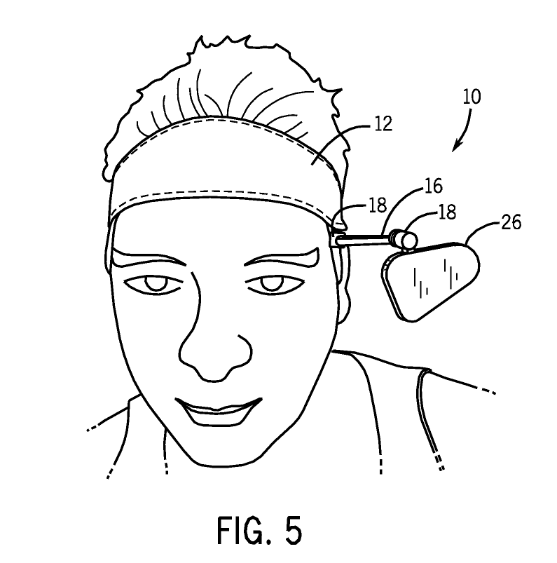

A strut 16 may be coupled to the pivot joint 18 at a first end thereof and may extend away from the pivot joint 18. A second, opposite end of the strut 16 may include a second pivot joint 18. A rearview mirror 14 may be attached to the pivot joint 18. The rearview mirror 14 may be a generally rectangular, or other geometric or non-geometric-shaped flat material with one side having a mirror disposed thereupon. In some embodiments, such as that shown in FIG. 5, a rearview mirror 26 may have an elongated shape to provide a wider angle of view behind the user.

The pivot joints 18 may be ball and socket type joints, permitting the members they join to move when a force is applied, but limiting their movement otherwise. For example, the pivot joints 18 may hold the relative positions of the rearview mirror 14, strut 16 and attachment member 20, even during exercise, such as cycling, running, skateboarding, or the like. In some embodiments, the pivot joints 18 may be integrally formed with one of the interconnecting members. For example, the pivot joint 18 may be formed integrally with the rearview mirror 14. In some embodiments, when the pivot joint 18 is a ball and socket type of joint, the ball may be formed on either of the components the pivot joint 18 joins. For example, the ball may be formed on the rearview mirror 14, or the ball may be formed on the strut 16, with the other component having the ball part of the joint.

In the above embodiment, the strut 16 may be a rigid member. However in some embodiments, the strut 16 may be a flexible member that may be flexed and hold its shape. In this embodiment, one or more of the pivot joints 18 may be eliminated.

It should be understood, of course, that the foregoing relates to exemplary embodiments of the invention and that modifications may be made without departing from the spirit and scope of the invention as set forth in the following claims.

What is claimed is:

1. A rearview mirror apparatus comprising:
a rearview mirror;
a strut;
a first pivot joint adapted to pivotally connect the rearview mirror with a first end of the strut;
an attachment member adapted to be attached to a headband; and
a second pivot joint adapted to pivotally connect the attachment member with a second, opposite end of the strut.

2. The rearview mirror apparatus of claim 1, wherein the first pivot joint and the second pivot joint are ball and socket joints.

3. The rearview mirror apparatus of claim 1, wherein the attachment member is a rectangular member having a height to fit inside a headband, with a top edge and a bottom edge of the attachment member being adjacent to a top inside edge and a bottom inside edge, respectively, of the headband.

4. A headband comprising:
an attachment member attached to the headband;
a rearview mirror;
a strut;
a first pivot joint adapted to pivotally connect the rearview mirror with a first end of the strut; and
a second pivot joint adapted to pivotally connect the attachment member with a second, opposite end of the strut.

5. The headband of claim 4, wherein the attachment member is disposed between an inner layer and an outer layer of the headband.

6. The headband of claim 4, wherein the first pivot joint and the second pivot joint are ball and socket joints.

7. The headband of claim 5, wherein the attachment member is a rectangular member having a height to fit inside a headband, with a top edge and a bottom edge of the attachment member being adjacent to a top inside edge and a bottom inside edge, respectively, of the headband.

8. A headband comprising:
an attachment member attached to the headband;
a rearview mirror;
a flexible strut connecting the rearview mirror with the attachment member.

9. The headband of claim 8, further comprising:
a first pivot joint adapted to pivotally connect the rearview mirror with a first end of the strut; and
a second pivot joint adapted to pivotally connect the attachment member with a second, opposite end of the strut.

10. The headband of claim 8, wherein the attachment member is disposed between an inner layer and an outer layer of the headband.
